(19) United States
(12) Patent Application Publication
(10) Pub. No.: US 2008/0149543 A1
(43) Pub. Date: Jun. 26, 2008

(54) DEVELOPING APPARATUS

(76) Inventors: Kazuhide UEMURA, Miyazaki (JP); Hiroshi Noma, Miyazaki (JP)

Correspondence Address: MILES & STOCKBRIDGE PC, 1751 PINNACLE DRIVE, SUITE 500, MCLEAN, VA, 22102-3833, US

(21) Appl. No.: 11/963,806

(22) Filed: Dec. 22, 2007

(30) Foreign Application Priority Data
Dec. 25, 2006 (JP) 2006-348152

(51) Int. Cl. B01D 43/00

(52) U.S. Cl. 210/151

(57) ABSTRACT

There is described a developing apparatus having function to remove scum occurring in a development process from a developer. The developing apparatus comprises a developing tank and the developing tank includes a developer inflow unit, a bubble accumulation unit, a scum removal unit, and a developer evacuation unit. The bubble accumulation unit makes a production speed of bubbles (including scum) included in a developer after development process inflowed from the developer inflow unit larger than a dissipation speed of the bubbles, thereby accumulating the bubbles. The scum removal unit takes in the bubbles including scum accumulated in the accumulation unit when the bubbles pour over the developing tank and removes the scum from the bubbles. The developer evacuation unit evacuates the scum-free developer from the developing tank for using the same in a development process.

### CROSS-REFERENCE TO RELATED APPLICATION

The present application claims priority from Japanese Patent Application No. JP 2006-348152 filed on Dec. 25, 2006, the content of which is hereby incorporated by reference into this application.

### TECHNICAL FIELD OF THE INVENTION

The present invention relates to a technique for a developing apparatus. More particularly, the present invention relates to a technique effectively applied to a developing apparatus having a function to remove scum occurring in development process.

### BACKGROUND OF THE INVENTION

Japanese Patent Application Laid-Open Publication No. 2006-301024 discloses a technique for removing and evacuating bubbles having scum attached thereto which are floating on the surface of a developer stored in a developer storage tank by spraying the developer onto the bubbles haying scum attached thereto from a plurality of spray nozzles. And, there is disclosed that, according to the technique, scum will not accumulate on the sidewall of the developer storage tank, thereby easing treatment of scum.

Japanese Patent Application Laid-Open Publication No. 2006-251278 discloses a technique for effectively collecting insoluble matter in a developer polluted after used for pattern formation on a substrate having a latent image formed thereon. More specifically, there is disclosed that attaching insoluble matter floating in the developer to bubbles and evacuating the bubbles having insoluble matter attached thereto to outside by a conveyer.

### SUMMARY OF THE INVENTION

For example, in a manufacturing process of a plasma display, pattering processes using photolithography technology are frequently used. As a patterning process using the photolithography technology, there is an electrode formation process for forming electrodes of a plasma display. In the electrode formation process, electrodes are formed by forming a desired electrode pattern using a dry film and a liquid resist film followed by etching. Specifically, after forming a dry film and a resist film, an exposure process is performed through a mask. And, a development process is performed using a developer to form a desired pattern. To develop the dry film and the negative resist film, alkali solutions such as sodium carbonate are used. In this development process, an insoluble initiator contained in the dry film and resist film will appear as scum. Scum means insoluble reaction product (matter).

Development process is performed by drawing out a developer from a tank storing the developer and pouring it on a target object. And, the developer is brought back to the tank. At this time, it means that the developer including scum is brought back to the tank. If scum is accumulated in the developer, the development process of the target object is performed with the developer including scum. Since scum is foreign matter, it will be attached to the target object as foreign matter and hinder normal patterning. Accordingly, removal of scum included in the developer by a filter and the like has been practiced.

However, when a filter is used for removing scum, the filter should be replaced. In other words, the filter is required to be replaced every constant period, and so it is problematic that not only maintenance but also running cost thereof is posed.

Consequently, as disclosed in Japanese Patent Application Laid-Open Publication No. 2006-301024 or Japanese Patent Application Laid-Open Publication No. 2006-251278, in consideration of a character of scum tending to attach to air bubbles, there are techniques for forcibly removing scum from a tank. For example, Japanese Patent Application Laid-Open Publication No. 2006-301024 discloses a technique of spraying a developer by a spray nozzle onto bubbles having scum attached thereto so that the bubbles having scum attached thereto are forcibly removed. And, Japanese Patent Application Laid-Open Publication No. 2006-251278 discloses a technique of producing bubbles to attach scum thereto and forcibly evacuating the bubbles having scum attached thereto to outside the tank by a conveyer. According to these techniques, since no filter is used, there are advantages that it is unnecessary to do maintenance and also running cost can be reduced. However, it is necessary to comprise forcible evacuating means for removing scum from the tank such as the spray nozzle and the conveyer. It means that it is necessary to provide forcible evacuating means to the developer storage tank, and thus there is a problem of posing equipment investment cost.

An object of the present invention is to provide a developing apparatus capable of reducing running cost as well as reducing equipment investment cost.

The above and other objects and novel characteristics of the present invention will be apparent from the description of this specification and the accompanying drawings.

The typical ones of the inventions disclosed in this application will be briefly described as follows.

A developing apparatus according to the present invention comprises (a) a developing tank to store a developer, and the developing tank includes: (a1) a developer inflow unit for inflowing a developer including scum and bubbles evacuated by a development process; (a2) a bubble accumulation unit for accumulating the bubbles which are included in the developer inflowed from the developer inflow unit by making a production speed of the bubbles having scum attached thereto faster than a dissipation speed of the bubbles; (a3) a scum removal unit for taking in the bubbles including scum which are stored in the bubble storage tank and overflowed from the developing tank in the ordinary course of events, so that the scum is removed from the bubbles; and (a4) a developer evacuation unit for evacuating the developer after removing scum from the developing tank to use the developer after removing scum for a development process.

The effects obtained by typical aspects of the present invention will be briefly described below.

It is possible to reduce equipment investment cost as well as reducing running cost.

### BRIEF DESCRIPTIONS OF THE DRAWINGS

FIG. 1 is a flow chart showing a manufacturing process of a plasma display device according to a first embodiment of the present invention;

FIG. 2 is a flow chart showing a process of photolithography using a resist film;

FIG. 3 is a flow chart showing a process of photolithography using a dry film;

FIG. 4 is a diagram showing a structure of a developing apparatus according to the first embodiment of the present invention;

FIG. 5 is a flow chart showing an operation of the developing apparatus according to the first embodiment of the present invention; and

FIG. 6 is a flow chart showing a manufacturing process of a semiconductor device according to a second embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

Herein, an example of an application of a developing apparatus according to a first embodiment of the present invention to a manufacturing process of a plasma display device.

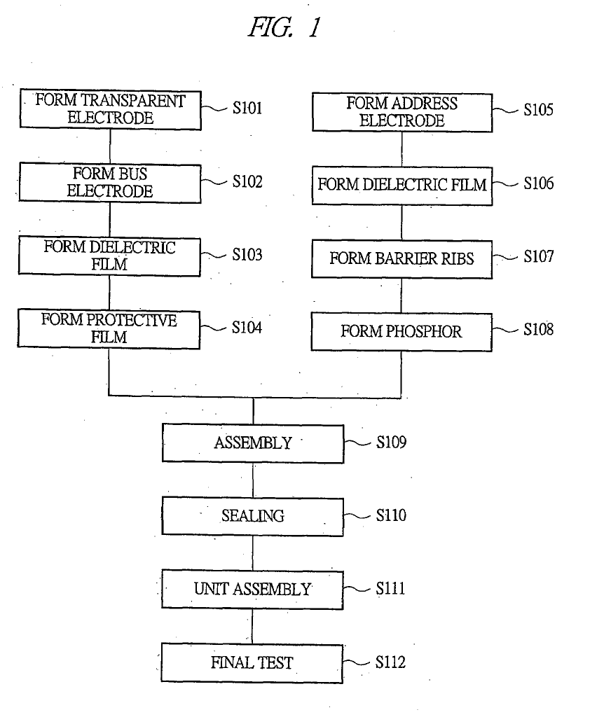

First, a description of the manufacturing process of a plasma display device for using the developing apparatus of the first embodiment is made with reference to FIG. 1. FIG. 1 is a flow chart showing the manufacturing process of a plasma display device.

As to FIG. 1, a glass substrate which is a substrate for a front substrate is prepared. And, by using photolithography technology and etching technology, a transparent electrode for configuring a display electrode is formed on a main surface of the glass substrate (S101). To form the transparent electrode, an oxidative product of indium and tin (ITO) which is a transparent material is formed on the glass substrate by, for example, sputtering. After that, a mask patterned by photolithography technology is formed, and ITO is etched by using the formed mask. In this manner, the transparent electrode can be formed. The display electrode functions to apply an electrical field to generate discharge and has two electrodes (called X electrode and Y electrode) formed in a pair.

Next, a BUS electrode is formed on the transparent electrode (S102). The BUS electrode is formed by, for example, sputtering by forming a three-layer film of chrome (Cr), copper (Cu), and chrome (Cr) and patterning the three-layer film by photolithography technology. Although the BUS electrode is formed of chrome (Cr), copper (Cu), and chrome (Cr) herein, it may be formed of silver (Ag). The BUS electrode functions to lower the electric resistance of the transparent electrode having a high electric resistance. Therefore, copper films are used to ensure a high conductivity and chrome films are used to ensure a thermal resistance. Further, the chrome film also functions to improve the adhesiveness between the transparent electrode and the BUS electrode.

Subsequently, a dielectric film is formed on the glass substrate having the display electrode formed by the BUS electrode and the transparent electrode (S103). The dielectric film is formed on the entire surface of the glass substrate to cover the display electrode. The dielectric film is formed for controlling current generated by a discharge and forming wall charge.

Next, a protective film is formed on the dielectric film (S104). The protective film is formed of, for example, magnesium oxide (MgO). The protective film functions to protect the dielectric film and decrease discharge voltage. The protective film is required to have a high ion-impact resistance and a high secondary-electron emission characteristic. In this manner, the front substrate used for one side of the plasma display panel is formed.

Subsequently, a process to form a back substrate as the other substrate of the display panel will be described. A glass substrate in addition to the front substrate is prepared and an address electrode is formed on this glass substrate (S105). The address electrode is formed of a three-layer film of chrome (Cr), copper (Cu), and chrome (Cr). Note that, the address electrode may be formed of a silver film. The address electrode functions to apply an electric field for generating discharge and to position an area (dot) for emission as well. The reason of using a copper film is that copper has high conductivity. Further, the chrome film is used because of its good thermal resistivity and good adhesiveness to the glass substrate.

Next, a dielectric film is formed on the entire surface of the glass substrate so as to cover the address electrode (S106). The dielectric film functions to control current generated by a discharge. Further, it functions to protect the address electrode and the glass substrate from sandblasting used for forming barrier ribs described below.

Subsequently, barrier ribs are formed on the dielectric film (S107). The barrier ribs are formed of, for example, low-melting glass. The barrier ribs form a discharge space and function to separate respective cells. The barrier ribs further function to enable application of phosphors on a bottom surface and side surfaces in a trench (cell) formed between the barrier ribs so that an area for applying the phosphors is increased. By increasing the area for applying the phosphors in this manner, it is possible to realize high luminance.

After that, the phosphors are applied in the trenches (cells) between the barrier ribs (S108). The phosphors are composed of respective types of metal oxides for emitting red, green, blue. Phosphors which emit light of red, green, and blue are respectively formed in the adjacent cells. In this manner, the back substrate which configures a part of the plasma display panel can be formed.

Next, the front substrate and the back substrate are cut. That is, the front substrate and the back substrate are formed so as to have a large area capable of obtaining a plurality of plasma display panels, and they are cut to configure individual display panel. And, the cut front and back substrates are adhered via a seal glass (sealant). In this process, the front substrate and the back substrate are integrally assembled (S109).

Subsequently, the cell space formed between the front and back substrates is evacuated. And, after the evacuation, a discharge gas is injected in the cell space. The discharge gas consists of, for example, a mixed gas of noble gases such as neon, xenon, and helium. The discharge gas is required to have a high ultraviolet emission efficiency and a low discharge voltage. Then, the cell space is sealed (S110). In this manner, the plasma display panel is manufactured.

Next, a driving circuit is connected to the plasma display panel, thereby assembling a unit (S111). In this unit assembling process, a flexible cable for connecting the plasma display panel and the driving circuit is bonded by thermocompression, thereby electrically connecting the plasma display panel and the driving circuit. After that, a final test (test of electrical characteristics) is performed (S112) and the plasma display panel is finished.

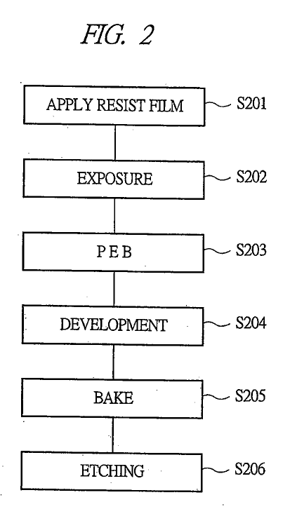

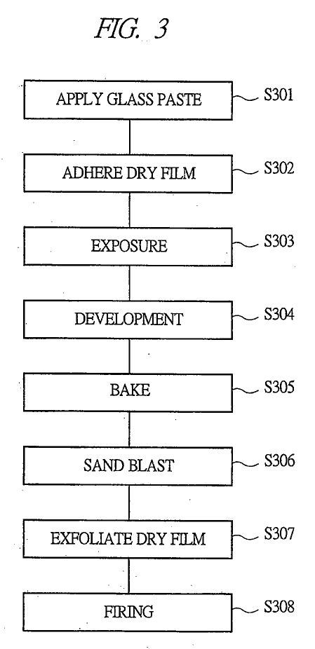

While the plasma display panel is manufactured in this manner, in the manufacturing process of a plasma display panel, the photolithography technology is frequently used as described above. A detailed description of a photolithography technology is made with reference to FIG. 2 and FIG. 3. In the photolithography technology, there is a process to pattern a liquid resist film and a dry film.

FIG. 2 is a flow chart showing a lithography process using a liquid resist film. This process is used for, for example, formation of a BUS electrode or the address electrode. Herein, a process of forming the transparent electrode is taken as an example. First, on the glass substrate, an ITO film formed of an oxide of indium and tin is formed by sputtering. And, as shown in FIG. 2, the resist film is formed on this ITO film by sputtering (S201). After that, an exposure process is performed on the applied resist film (S202). The exposure process is performed by irradiating exposing light on the resist film through a mask to which a transparent electrode pattern is formed.

Next, a PEB (Post Exposure Bake) is performed depending on the type of the resist film (S203). PEB is a light thermal process to be performed after an exposure process. PEB is performed with the aim of smoothing a jagged pattern edge due to an influence of standing wave in the exposure, and further, when the resist film is a chemically-amplified resist film, PEB is performed with the aim of accelerating production of acid by catalytic reaction.

Subsequently, a development process is performed (S204). Development process is a process to expose a latent pattern transferred on the resist film through the exposure process by utilizing chemistry. Development process is generally done by wet development method using chemicals called developer. Pattern formation is performed by dissolving the resist film of the part irradiated by light as to a positive resist films and the part unexposed as to a negative resist film on the contrary. Development process includes a dip method for dipping a target object in a developer and a spray method for spraying a developer on a target object in the form of a mist.

By performing a development process in this manner, the resist film is patterned. And, a baking is performed for removing the developer from the glass substrate (S205). Next, through an etching taking the patterned resist film as a mask (S206), the ITO film of a lower layer of the resist film is patterned, thereby forming a display electrode. In this manner, the photolithography technology is used in the process of transparent electrode formation.

Next, in the manufacturing process of a plasma display device, there is a process to perform a patterning using a film having a resist film formed thereon, i.e., a dry film instead of a liquid resist film. For example, as a process utilizing a photolithography using a dry film, there is a process of barrier rib formation. As exemplifying this process of barrier rib formation, the photolithography process using dry film is described.

As shown in FIG. 3, a glass paste is applied on the glass substrate (S301). Then, a dry film is adhered on the glass paste (S302). After that, on the dry film, exposure light is irradiated through a mask (S303). Subsequently, a development process is performed on the dry film irradiated by the exposure light through the mask (S304). Next, a baking is performed to remove the developer (S305). In this manner, the dry film can be patterned. The patterning on dry film is performed so as not to leave the dry film in the region to form barrier ribs.

Next, through a sandblasting taking the patterned dry film as a mask, barrier ribs are formed on the glass paste (S306). Subsequently, after exfoliating the patterned dry film (S307), the barrier ribs can be formed on the glass substrate by firing (S308). In this manner, barrier ribs can be formed through the photolithography technology using a dry film.

As shown in FIG. 2 and FIG. 3, the manufacturing process of a plasma display device includes the patterning process using a resist film and the patterning process using a dry film, and it can be said that both lithography processes include a development process. In other words, development process is indispensable in the photolithography technology. Hereinafter, a developing apparatus to be used in a development process will be described. A feature of the first embodiment of the present invention lies in this developing apparatus.

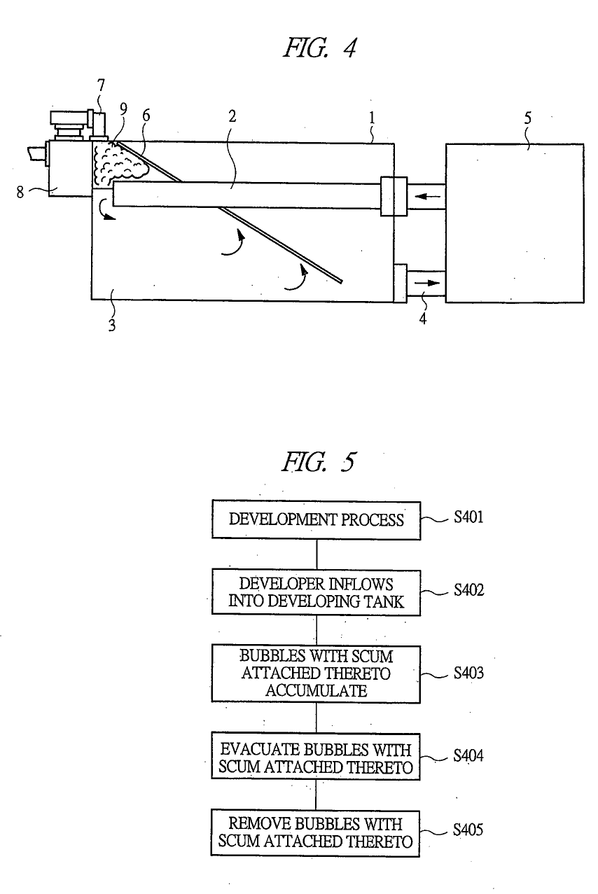

FIG. 4 is a diagram showing a structure of the developing apparatus according to the first embodiment. In FIG. 4, a developing tank 1 which is a feature of the first embodiment is shown. As shown in FIG. 4, to the developing tank 1, a developer inflow unit 2 to inflow a developer 3 there to and a developer evacuating unit 4 for evacuating the developer 3 from the developing tank 1 are provided. The developer inflow unit 2 and the developer evacuating unit 4 provided to the developing tank 1 are connected with a developing unit 5. That is, a development is performed on a target object in the developing unit 5 and the developer 3 after the development is inflowed from the developing unit 5 to the developer inflow unit 2 through a pipe. On the other hand, the developer 3 stored in the developing tank 1 is flowing into the developing unit 5 via the developer evacuating unit 4. In this manner, this is a configuration in which the developer 3 is circulating between the developing tank 1 and the developing unit 5.

The developing unit 5 is configured to perform development by contacting the developer 3 onto the target object such as a glass substrate having a resist film formed thereon. That is, the developing unit 5 performs a process to expose a latent pattern transformed on the resist film through an exposure process by utilizing chemistry. Pattern formation is performed on the part irradiated by light as to a positive resist film and the part unexposed as to a negative resist film on the contrary by dissolving the resist film in the developer. In the development process, there are the dip method for dipping the target object in the developer 3 and the spray method for spraying the developer 3 on the target object in the form of a mist. Either of the dip method or the spray method described above can be used to configure the developing unit 5 according to the first embodiment.

In the development process by the developing unit 5, part of the resist film formed on the target object is dissolved by chemistry with the developer 3, thereby forming a pattern on the resist film. At this time, from the resist film dissolved in the developer 3, an insoluble initiator appears to be scum (foreign matter). In addition, the developer 3 tends to bubble and thus bubbles of air bubble are contained in the developer 3. The developer 3 thus introduced to the development process contains bubbles and scum. The developer 3 containing bubbles and scum inflows to the developing tank 1 from the developing unit 5 through the developer inflow unit 2 after the development process ends.

The developer 3 inflows to the developing tank 1 from the developer inflow unit 2 and scum and bubbles are mixed in the developer 3. The inflowed developer 3 bubbles on the surface of the developer 3 having been stored in the developing tank 1. In other words, due to the developer 3 inflowing into the developing tank 1, bubbles 9 are produced on the surface of the stored developer 3 in the developing tank 1. This is because a dissipation speed of the bubbles 9 is larger than a production speed of the bubbles 9 in the inflowed developer 3. Further, since the scum included in the inflowed developer 3 has a characteristic of tendency to attach to the bubbles, the scum is more likely to attach to the produced bubbles 9. That is, most of the scum included in the inflowed developer 3 attaches to the bubbles 9.

At this time, while the bubbles 9 are produced on the surface of the developer 3 stored in the developing tank 1, the bubbles 9 can be spread to the entire surface of the developer 3 when a partition plate 6 is not provided. Therefore, the push-out force of the bubbles themselves is weak and so the bubbles 9 do not pour over the developing tank 1 by themselves. Meanwhile, the first embodiment of the present invention provides the partition plate 6 as shown in FIG. 4. This point is a feature of the first embodiment. The partition plate 6 provided narrows the space for the bubbles 9 produced on the surface of the developer 3 to move. More specifically, the partition plate 6 is arranged obliquely to the surface of the developer 3 stored in the developing tank 1 so that the space partitioned by the partition plate 6 gets to be smaller upward from the liquid level of the developing tank 1 in which the bubbles 9 are created. Therefore, the bubbles 9 produced are trapped inside the small space partitioned by the partition plate 6. Consequently, the bubbles 9 produced one after another due to the inflowing developer 3 have nowhere to escape and be pushed out upward to the small space partitioned by the partition plate 6. In other words, according to the first embodiment of the present invention, the volume of the space where the bubbles can exist is made to be small by providing the partition plate 6, thereby increasing the push-out force of the bubbles 9 themselves and moving the bubbles 9 upward the developing tank 1 by the natural push-out force created in the bubbles 9 themselves. In this manner, the first embodiment is configured to make the bubbles 9 pour over the upper side of the developing tank 1 by the natural push-out force produced by the production of the bubbles 9. The part configured by the partition plate 6 is a bubble accumulation unit of the first embodiment.

The bubbles 9 trapped by providing the partition plate 6 as described above is evacuated over the developing tank 1 and moved to the pipe 7 arranged on the upper side of the developing tank 1. And, the bubbles 9 move to a scum removal unit 8 arranged on a side of the developing tank 1 through the pipe 7. Scum is attached on the bubbles 9 and the bubbles 9 with the scum attached thereon are evacuated to a waste line by the scum removal unit 8 and thus removed. In other words, by removing the bubbles 9, the scum attached on the bubbles 9 can be removed. Note that, in order to make the bubbles 9 smoothly move to the scum removal unit 8, the pipe 7 can be oblique so as to make the part connected with the scum removal unit 8 to be lower.

When the scum is accumulated in the developer 3, the development process of the target object is performed with the developer 3 including the scum. Since the scum is foreign matter, the target object gets the scum as foreign matter attached and it hinders the normal patterning. According to this, it is necessary to remove the scum included in the developer 3. Conventionally, a filter is used to remove the scum included in the developer 3. However, in the case where a filter is used to remove scum, it is necessary to replace the filter every constant period. In other words, since it is necessary to replace the filter every constant period, a problem arises that not only maintenance is required but also running cost is caused.

As methods to solve this problem, as disclosed in Japanese Patent Application Laid-Open Publication No. 2006-301024 or Japanese Patent Application Laid-Open Publication No. 2006-251278, there are techniques to forcibly remove scum from the tank considering the characteristic of scum to float on the surface of the developer. For example, Japanese Patent Application Laid-Open Publication No. 2006-301024 discloses that, the developer is sprayed onto the bubbles with scum attached thereto so that bubbles including scum are forcibly removed. And, Japanese Patent Application Laid-Open Publication No. 2006-251278 discloses that, air bubbles are created to make scum attach to the air bubbles so that the bubbles having scum attached thereto are forcibly evacuated outside the tank by a conveyer. According to these techniques, since no filter is used, there are advantages that it is unnecessary to do maintenance and also running cost can be reduced. However, it is necessary to comprise forcible evacuating means for removing scum from the tank such as a spray nozzle and a conveyer. It means that it is necessary to provide forcible evacuating means to the developer storage tank, and thus there is a problem of equipment investment cost.

With respect to these problems, in the first embodiment of the present invention, the space where the bubbles 9 can exit is made to be small by means of the partition plate 6, so that the push-out force of the bubbles 9 themselves is increased and thus the bubbles 9 are moved to the upside in the developing tank 1 by the natural push-out force produced in the bubbles 9 themselves. In other words, without providing forcible evacuating means for evacuating the bubbles 9 to the developing tank 1, the bubbles 9 are evacuated from the developing tank 1 by increasing the natural push-out force produced in the bubbles 9. In this manner, it is unnecessary to provide forcible evacuating means for evacuating the bubbles 9 to the developing tank 1, thereby reducing equipment investment cost. Moreover, since a filter is unnecessary, it is unnecessary to do maintenance and also running cost can be reduced.

Although it is configured to remove the bubbles 9 including scum in the scum removal unit 8, it is not limited to this but, for example, it can be configured to trap scum included in the bubbles 9 by an inexpensive mat (filter) and take back the developer 3 excluding the scum liquefied from the bubbles 9. Although a mat is required in this case, the conventional configuration providing a filter in the developer 3 requires to remove the developer for replacing the filter. Therefore, while it takes time to do maintenance, the configuration where a mat is provided to the scum removal unit 8 separately from the developing tank 1 can leave the developer stored in the developing tank undisturbed when the mat is replaced, thereby improving a maintenance ability. However, it is required to replace the mat and thus running cost is posed. Therefore, in view of reducing running cost, as the first embodiment, it is preferable to remove whole the bubbles 9 including scum.

Further, although the pipe 7 for evacuating the bubbles 9 from the developing tank 1 is provided on the upper side of the developing tank 1 in the first embodiment of the present invention, for example, the pipe 7 can be provided on a side of the developing tank 1. However, it is preferable to provide the pipe 7 on the upper side of the developing tank 1 because it is possible to avoid the developer 3 from overflowing through the pipe 7 if the liquid amount of the developer 3 stored in the developing tank 1 is increased rather than providing the pipe 7 on the side of the developing tank 1.

Further, in the first embodiment of the present invention, the developer inflow unit 2 is provided near the surface of the developer 3 and the developer evacuating unit 4 is provided near a bottom surface of the developing tank 1. Therefore, it is easy for scum tending to attach to bubbles to be attached to the bubbles 9 produced on the surface of the developer 3. In other words, although scum is included in the developer 3 inflowing from the developer inflow unit 2, since the developer inflow unit 2 is provided near the surface of the developer 3, it can make the scum inflowed from the developer inflow unit 2 to the developing tank 1 easy to attach to the bubbles 9 which are produced adjacent to the surface of the developer 3. And, by providing the developer evacuating unit 4 near the bottom surface of the developing tank 1 away from the surface of the developer 3 where the bubbles 9 with scum attached thereto exist, it is possible to make scum to be included in the developer 3 evacuated from the developer evacuating unit 4 as little as possible.

Furthermore, as shown in FIG. 4, an inflowing direction of the developer 3 due to the developer inflow unit 2 and an evacuating direction of the developer 3 due to the developer evacuating unit 4 are opposite to each other. This is because, the partition plate 6 provided on the stored developer 3 can make the direction of the inflowing developer 3 so as to direct to the surface of the developer 3, thereby taking the scum existing in the developer 3 not attached to the bubbles 9 back to the surface of the developer 3 again even when the scum inflowed from the developer inflow unit 2 does not immediately attach to the bubbles 9. Therefore, it is possible to improve efficiency of attaching scum to the bubbles 9 and reducing scum to be included in the developer 3.

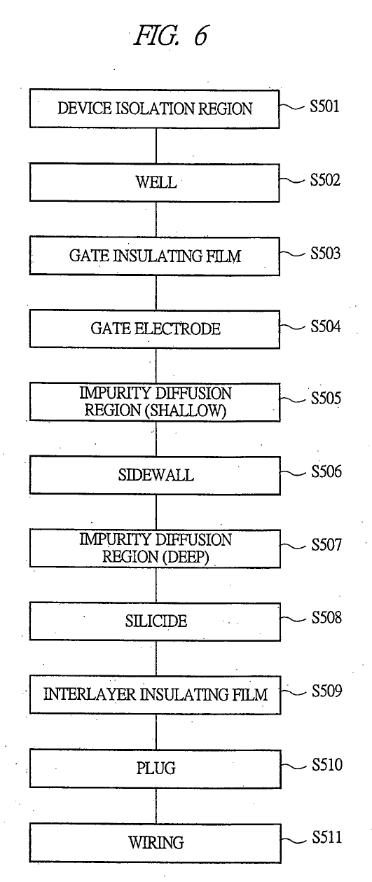

The developing apparatus of the first embodiment of the present invention is configured as described above, and its operation is described hereinafter with reference to FIG. 4 and FIG. 5.

First, in the developing unit 5, the development process is performed by contacting the developer 3 with the target object (S401). After performing the development process, the developer includes scum and bubbles. The developer 3 including scum and bubbles inflows to the developing tank 1 from the developer inflow unit 2 through a pipe (S402). At this time, the developer 3 bubbles and the bubbles 9 are produced on the surface of the developer 3 having been stored in the developing tank 1. Scum included in the inflowed developer 3 attaches to the bubbles 9. And, as the developer 3 continuously inflows, the bubbles 9 are accumulated in the developer tank 1 (S403). At this time, since the partition plate 6 is provided in the developing tank 1, the space for the bubbles to be accumulated is small. Therefore, the bubbles produced one after another due to the inflowing developer 3 have nowhere to escape and are naturally pushed out upwards in the small space partitioned by the partition plate 6. In other words, by making the volume of the space where the bubbles 9 can exist by providing the partition plate 6, the push-out force of the bubbles is increased, so that the bubbles 9 are moved to the upside of the developing tank 1 by the natural pushing-up force produced in the bubbles 9 themselves. And, the bubbles 9 are naturally evacuated to the pipe 7 from the upper part of the developing tank 1 (S404). The evacuated bubbles 9 enter the scum removal unit 8 and the bubbles having scum attached thereto are removed from the waste line (S405).

In this manner, the scum included in the developer 3 can be removed. Therefore, the scum included in the developer can be removed, thereby reducing patterning failure in the development process. Particularly, since it is possible to remove scum from the developer 3 without using a filter in the present first embodiment, there is no need to do maintenance to replace a filter, thereby reducing running cost. Moreover, since the bubbles including scum are naturally evacuated by the push-out force produced when the bubbles 9 are accumulated, there is no need to provide forcible evacuating means for evacuating the bubbles 9 including scum. Therefore, it is possible to reduce equipment investment cost.

According to the foregoing, by means of the developing apparatus of the first embodiment of the present invention, it is possible to reduce running cost as well as reducing equipment investment cost in a manufacturing process of a plasma display device.

### Second Embodiment

In the above first embodiment, the developing apparatus of the present invention has been described exemplifying the manufacturing process of a plasma display device. Meanwhile, in a second embodiment, an example to apply the developing apparatus of the present invention to a manufacturing process of a semiconductor device.

First, as one example of the manufacturing process of a semiconductor device, a manufacturing process of a CMISFET (Complementary Metal Insulator Semiconductor Field Effect Transistor) will be described. With reference to FIG. 1, the manufacturing method of a CMISFET will be described. FIG. 6 is a flow chart showing the manufacturing method of a CMISFET.

First, a semiconductor substrate made by single crystal silicon to which a p-type impurity such as boron (B) is introduced is prepared. At this time, the semiconductor substrate is in a state of a roughly-disk-shaped semiconductor wafer. And, a device isolation region for isolating devices is formed in a CMISFET formation region of the semiconductor substrate (S501). The device isolation region is provided for preventing devices from interfering each other. The device isolation region can be formed through the LOCOS (Local Oxidation of Silicon) method and STI (Shallow Trench Isolation) method. For example, in the STI method, the device isolation region is formed as the following. More specifically, a device isolation trench is formed by using photolithography technology and etching technology to the semiconductor substrate. And, a silicon oxide film is formed on the semiconductor substrate so as to fill the device isolation trench, and then the unnecessary silicon oxide film formed on the semiconductor substrate is removed through the CMP (Chemical Mechanical Polishing) method. In this manner, the device isolation region where the silicon oxide film is filled in only the device isolation trench can be formed.

Next, a well is formed by introducing an impurity into active regions isolated by the device isolation region (S502). For example, among the active regions, a p-type well is formed in an n-channel type MISFET formation region and an n-type well is formed in a p-channel type MISFET formation region. The p-type well is formed by introducing a p-type impurity such as boron through an ion-implantation method. Similarly, the n-type well is formed by introducing an n-type impurity such as phosphorus (P) and arsenic (As) through an ion-implantation method.

Subsequently, semiconductor regions (now shown) for channel formation are formed in a surface region of the p-type well and a surface region of the n-type well. The semiconductor regions for channel formation are formed for adjusting a threshold voltage to form a channel.

Next, a gate insulating film is formed on the semiconductor substrate (S503). The gate insulating film is, for example, formed by a silicon oxide film and it can be formed by using a thermal oxidation method. Note that, the gate insulating film is not limited to a silicon oxide film and various modifications can be made. For example, the gate insulating film can be a silicon oxynitride film (SiON). In other words, it can be a structure where nitride is segregated on an interface of the gate insulating film and the semiconductor substrate. A silicon oxynitride film suppresses occurrence of interface states in the film than a silicon oxide film and is highly effective to reduce electron traps. Therefore, a hot-carrier resistance of the gate insulating film can be improved, thereby improving a dielectric strength. Further, it is difficult for impurities to penetrate through a silicon oxynitride film than a silicon oxide film. Therefore, by using a silicon oxynitride film for the gate insulating film, variations in the threshold voltage due to the impurities in the gate electrode diffusing toward the semiconductor side can be suppressed. To form a silicon oxynitride film, the semiconductor substrate may be introduced to a thermal process in an atmosphere including nitride like NO, NO₂, or NH₃. Further, similar effects can be obtained in a way where, after forming the gate insulating film formed by a silicon oxide film, the semiconductor substrate is introduced to a thermal process in an atmosphere including nitride and segregating nitride to the interface of the gate insulating film and the semiconductor substrate.

And, the gate insulating film may be formed of, for example, a high-dielectric-constant film having a higher dielectric constant than a silicon oxide film. Conventionally, silicon oxide films have been used in view of its high dielectric strength and good electric and physical stabilities at the interface of silicon and silicon oxide.

However, along with scaling of devices, the thickness of gate insulating films has been required to be extremely thin. If a silicon oxide film being that thin is used for the gate insulating film, electrons flowing in the channel of MISFET tunnel through the barrier formed by the silicon oxide film and flows to the gate electrode, i.e., the tunneling current will occur.

Accordingly, by using materials having higher dielectric constants than the silicon oxide film, high-dielectric-constant films capable of making the physical thickness thicker while the capacitance is the same have been getting to be used. By means of high-dielectric-constant films, it is possible to increase the physical thickness while keeping the capacitance same, thereby reducing leakage current.

For example, as a high-dielectric-constant film, a film of hafnium oxide (HfO₂ film) which is one of hafnium oxides is used, however, other hafnium-system insulating films such as a hafnium aluminate film, HfON film (hafnium oxynitride film), HfSiO film (hafnium silicate film), HfSiON film (hafnium silicon oxynitride film), and HfAlO film can be used. Moreover, hafnium-system insulating films which are obtained by introducing tantalum oxide, niobium oxide, titanium oxide, zirconium oxide, lanthanum oxide, yttrium oxide and the like into these hafnium-system insulating films can be used. Since hafnium-system insulating films have higher dielectric constants than the silicon oxide film and silicon oxynitride film similarly to the hafnium oxide film, same effects with those obtained by using the hafnium oxide film can be obtained.

Subsequently, a polysilicon film is formed on the gate insulating film. The polysilicon film can be formed by using a CVD method. And, by using photolithography technology and ion implantation method, an n-type impurity such as phosphorus and arsenic is introduced into the polysilicon film formed in the n-channel type MISFET formation region. Similarly, a p-type impurity such as boron is introduced into the polysilicon film formed in the p-channel type MISFET formation region.

Next, the polysilicon film is processed by etching using a patterned resist film as a mask so that gate electrodes are formed in the n-channel type MISFET formation region and p-channel type MISFET formation region (S504).

Herein, as to the gate electrode of the n-channel type MISFET formation region, an n-type impurity is introduced into the polysilicon film. Therefore, it is possible to make a work function value of the gate electrode to be near the conduction band of silicon (4.15 eV), thereby reducing a threshold voltage of the n-channel type MISFET. On the other hand, as to the gate electrode of the p-channel type MISFET formation region, a p-type impurity is introduced into the polysilicon film. Therefore, it is possible to make a work function value of the gate electrode to be near the valence band of silicon (5.15 eV), thereby reducing a threshold voltage of the p-channel type MISFET. According to the present first embodiment in this manner, it is possible to reduce the threshold voltages of both the n-channel type MISFET and the n-channel type MISFET (Dual Gate Structure).

Subsequently, by using photolithography technology and ion implantation method, a shallow n-type impurity diffusion region aligned with the gate electrode of the n-channel type MISFET is formed. The shallow n-type impurity diffusion region is a semiconductor region. Similarly, a shallow p-type impurity diffusion region is formed in the p-channel type MISFET formation region. The shallow p-type impurity diffusion region can be formed by using photolithography technology and ion implantation method (S505).

Next, a silicon oxide film is formed on the semiconductor substrate. The silicon oxide film can be formed by, for example, CVD method. And, by anisotropically etching the silicon oxide film, sidewalls are formed on sidewalls of the gate electrode (S506). The sidewalls are formed of a single layer of silicon oxide film, however, it is not limited to this and sidewalls formed of, for example, a stacked-layer film of a silicon nitride film and a silicon oxide film can be formed.

Subsequently, by using photolithography and ion implantation method, a deep n-type impurity diffusion region aligned with the sidewalls is formed in the n-channel type MISFET formation region (S507). The deep n-type impurity diffusion region is a semiconductor region. A source region is formed by this deep n-type impurity diffusion region and the shallow n-type impurity diffusion region. Similarly, a drain region is formed by the deep n-type impurity diffusion region and the shallow impurity diffusion region. In this manner, by forming the source region and the drain region by the shallow n-type impurity diffusion regions and the deep n-type impurity diffusion regions, the source and drain regions can be the LDD (Light Doped Drain) structure.

Similarly, a deep p-type impurity diffusion region aligned with the sidewalls is formed in the p-channel type MISFET formation region. A source region and drain region are formed by this deep p-type impurity diffusion region and shallow p-type impurity diffusion region. Therefore, the p-channel type MISFET also has the LDD structure.

In this manner, after forming the deep n-type impurity diffusion region and deep p-type impurity diffusion region, a thermal process of about 1000° C. is performed. Consequently, activation of the impurities introduced is done.

After that, a cobalt film is formed on the semiconductor substrate. At this time, the cobalt film is formed so as to contact the gate electrode directly. Similarly, the cobalt film directly contact with the deep n-type impurity diffusion region and deep p-type impurity region.

The cobalt film can be formed by, for example, sputtering method. And, after forming the cobalt film, through a thermal process, the polysilicon film and the cobalt film configuring the gate electrode are reacted, thereby forming a cobalt silicide film (S508). In this manner, the gate electrode becomes a stacked-layer structure of the polysilicon film and cobalt silicide film. The cobalt silicide film is formed for lowering a resistance of the gate electrode. Similarly, through the thermal process described above, on surfaces of the deep n-type impurity diffusion region and the deep p-type impurity diffusion region, silicon and the cobalt film react, thereby forming cobalt silicide films. Therefore, it is possible to lower resistances in the deep n-type impurity diffusion region and also the deep p-type impurity diffusion region.

And then, the unreacted cobalt film is removed from the semiconductor substrate. Note that, in the second embodiment of the present invention, it is configured to form the cobalt silicide film, however, instead of the cobalt silicide film, a nickel silicide film and a titanium silicide film may be used.

Next, a silicon oxide film to be an interlayer insulating film is formed on a main surface of the semiconductor substrate (S509). This silicon oxide film can be formed by, for example, CVD method using TEOS (tetraethyl orthosilicate) as its source material. After that, a surface of the silicon oxide film is planarized by using CMP (Chemical Mechanical Polishing).

Subsequently, by using photolithography technology and ion implantation method, a contact hole is formed in the silicon oxide film. And, a titanium/titanium-nitride film is formed on the silicon oxide film including a bottom surface and inner walls of the contact hole. The titanium/titanium-oxide film is formed of a stacked-layer film of a titanium film and a titanium nitride film, and formed by using, for example, spattering method. This titanium/titanium-oxide film has, for example, so-called barrier property for preventing tungsten which is a material of film to be buried in the following process from diffusing into silicon.

Subsequently, a tungsten film is formed on the entire main surface of the semiconductor substrate so as to bury the contact hole. This tungsten film can be formed by using, for example, CVD method. And, the unnecessary titanium/titanium-oxide film and tungsten film formed on the silicon oxide film are removed by, for example, CMP method, thereby forming a plug (S510).

Next, a titanium/titanium-nitride film, an aluminum film containing copper, and a titanium/titanium-nitride film are sequentially formed on the silicon oxide film and the plug. These films can be formed by, for example, using sputtering. Subsequently, by using photolithography technology and etching technology, these films are patterned so that a wiring is formed (S511). Further, another wiring is formed in an upper layer of the wiring, however, the description is omitted herein. In this manner, the semiconductor device of the second embodiment of the present invention can be formed.

Photolithography technology is frequently used also in the manufacturing method of a semiconductor device described above. And, a development process is performed in the photolithography technology. Therefore, the developing apparatus of the present invention is also applicable to a manufacturing method of a semiconductor device. In other words, also in a manufacturing method of a semiconductor device, by using the developing apparatus described in the above first embodiment, scum included in the developer can be removed. Therefore, since scum included in the developer can be removed, pattern failure in a development process can be reduced. Particularly, also in the second embodiment of the present invention, since scum can be removed from the developer without using a filter, there is no need to do maintenance to replace a filter and running cost can be reduced. Moreover, bubbles including scum are naturally evacuated by the push-out force produced during the bubbles accumulating. Therefore, there is no need to provide forcible evacuating means for evacuating bubbles including scum. Consequently, equipment investment cost can be reduced.

According to the foregoing, by means of the developing apparatus of the second embodiment of the present invention, it is possible to reduce equipment investment cost as well as reducing running cost in a manufacturing process of a semiconductor device.

In the foregoing, the invention made by the inventors of the present invention has been concretely described based on the first and second embodiments. However, it is needless to say that the present invention is not limited to the foregoing embodiments and various modifications and alterations can be made within the scope of the present invention.

In the above first embodiment, an example for applying the developing apparatus of the present invention to a manufacturing process of a plasma display device was described, and in the above second embodiment, an example for applying the developing apparatus of the present invention to a manufacturing process of a semiconductor device was described. The examples for applying the developing apparatus of the present invention to these manufacturing processes are described merely for purposes of illustration, and it is applicable to various processes performing development processes in photolithography technology. For example, the developing apparatus of the present invention is also applicable to a manufacturing process of a liquid crystal display.

The present invention is widely usable in manufacturing industries using photolithography technology.

What is claimed is:

1. A developing apparatus comprising (a) a developing tank for storing a developer,
wherein the developing tank includes:
(a1) a developer inflow unit for inflowing a developer including scum and bubbles evacuated by performing a development process to the developing tank;
(a2) a bubble accumulation unit for accumulating the bubbles in the developing tank by making a production speed of the bubbles including the scum which are bubbles included in the developer inflowed from the developer inflow unit larger than a dissipation speed of the bubbles;
(a3) a scum removal unit for removing the scum from the bubbles by taking in the bubbles including the scum accumulated in the bubble accumulation unit when they pour over the developing tank; and
(a4) a developer evacuation unit for evacuating the developer with the scum being removed from the developing tank for using the same in a development process.

2. The developing apparatus according to claim 1,
wherein a partition plate is provided in the developing tank as the bubble accumulation unit for making a space for the bubbles to accumulate smaller than not providing the partition plate, so that it is easy for the accumulated bubbles to pour over the developing tank.

3. The developing apparatus according to claim 2,
wherein the partition plate is arranged to be oblique to the developing tank, so that a space partitioned by the partition plate gets smaller upwards from a liquid level of the developer tank where the bubbles are produced.

4. The developing apparatus according to claim 1,
wherein the scum removal unit removes whole the bubbles including scum.

5. The developing apparatus according to claim 1,
wherein an inflowing direction of the developer of the developer inflow unit and an evacuating direction of the developer evacuation unit are opposite.
